(19) United States
(12) Patent Application Publication
(10) Pub. No.: US 2016/0031483 A1
(43) Pub. Date: Feb. 4, 2016

(54) AXLE MOUNTING SYSTEM AND VEHICLE

(71) Applicants: Oliver KUTTNER, Lynchburg, VA (US); Gene LUKIANOV, Beverly Hills, MI (US); EDISON2, Lynchburg, VA (US)

(72) Inventors: Oliver KUTTNER, Lynchburg, VA (US); Gene LUKIANOV, Beverly Hills, MI (US)

(21) Appl. No.: 14/777,273

(22) PCT Filed: Mar. 14, 2014
(86) PCT No.: PCT/US14/28025

§ 371 Date: Sep. 15, 2015

Related U.S. Application Data
(60) Provisional application No. 61/793,311, filed on Mar. 15, 2013.

(51) Int. Cl. B62D 21/02; B62D 21/11; B60G 9/04

(52) U.S. Cl. CPC B62D 21/02; B60G 9/04; B62D 21/11

(57) ABSTRACT

An axle mounting system that includes a first axle bracket, an axle connected to the first axle bracket, a first wheel disposed on the axle, the first wheel defining a first contact region when in contact with a ground, a first upper bushing connected to the first axle bracket, and a first lower bushing connected to the first axle bracket. The first upper bushing and the first lower bushing are adapted to connect the first axle bracket to a chassis of a vehicle disposed on the ground. The first upper bushing is disposed apart from the first lower bushing, thereby forming a line that, in one embodiment, intersects the ground at or ahead of a first edge of the first contact region. In one contemplated embodiment, the line establishes an angle with the ground.

### CROSS-REFERENCE TO RELATED APPLICATION(S)

This Patent Cooperation Treaty (“PCT”) Patent Application relies for priority on U.S. Provisional Patent Application Ser. No. 61/793,311, filed on Mar. 15, 2013, the entire contents of which are incorporated herein by reference.

### FIELD OF THE INVENTION

The present invention is directed to an axle mounting system, such as the type that may be employed on a four-wheeled vehicle. In particular, the present invention may be applied to automobiles.

### DESCRIPTION OF THE RELATED ART

The prior art is replete with examples of systems for mounting axles to vehicles such as cars.

In many examples in the prior art, it is typical to position one or more bushings, oriented horizontally (i.e., a bushing array disposed on a horizontal plane or defining a horizontal plane), between a drive axle and the chassis of the vehicle to dampen motion between the drive axle and the chassis.

A need, however, has developed for an attachment system that relies on a non-conventional orientation for the attachment of an axle to the chassis of a vehicle, such as an automobile.

### SUMMARY OF THE INVENTION

The present invention provides an axle mounting system where connective bushings are oriented substantially on vertically plane (i.e., not a horizontal plane) between the axle of the vehicle and the vehicle chassis.

The bushings are disposed on vertical planes (hereinafter referred to as a “vertical orientation”) such that they form lines that converge substantially toward a center of the vehicle, when the vehicle is viewed from the side, sitting on the ground.

With the bushings arranged in a vertical orientation, and aligned along convergent lines, when taken with other features that are made apparent herein, the axle mounting system of the present invention helps to drive compliance of the car into an understeer condition, with the advantages associated with understeer.

One contemplated embodiment of the present invention provides a front axle mounting system that includes a first front axle bracket, a front axle connected to the first front axle bracket, a first front wheel disposed on the front axle, the first front wheel defining a first front contact region when in contact with a ground, a first upper front bushing connected to the first front axle bracket, and a first lower front bushing connected to the first front axle bracket. The first upper front bushing and the first lower front bushing are adapted to connect the first front axle bracket to a chassis of a vehicle disposed on the ground. The first upper front bushing is disposed apart from the first lower front bushing, thereby forming a front line that intersects the ground at or ahead of a first forward edge of the first front contact region. The front line establishes a front angle with the ground.

In another contemplated embodiment, the front axle system includes a second lower front bushing connected between the front axle and the chassis.

In a further contemplated embodiment, the front axle system includes a second front wheel disposed on the front axle, the second front wheel defining a second front contact region when in contact with the ground, a second front axle bracket, spaced apart from the first front axle bracket, and connected to the front axle, a second upper front bushing connected to the second front axle bracket, and a second lower front bushing connected to the second front axle bracket. The second upper front bushing and the second lower front bushing are adapted to connect the second front axle bracket to the chassis. The second upper front bushing is disposed apart from the second lower front bushing, thereby also forming the front line that intersects the ground at or ahead of a second forward edge of the second front contact region.

The present invention also provides for a rear axle mounting system. The rear axle mounting system includes a first rear axle bracket, a rear axle connected to the first rear axle bracket, a first rear wheel disposed on the rear axle, the first rear wheel defining a first rear contact region when in contact with a ground, a first upper rear bushing connected to the first rear axle bracket, and a first lower rear bushing connected to the first rear axle bracket. The first upper rear bushing and the first lower rear bushing are adapted to connect the first rear axle bracket to a chassis of a vehicle disposed on the ground. The first upper rear bushing is disposed apart from the first lower rear bushing, thereby forming a rear line that intersects the ground at or behind a first rearward edge of the first rear contact region. The rear line establishes a rear angle with the ground.

In a further contemplated embodiment of the rear axle mounting system, a second lower rear bushing is connected between the rear axle and the chassis.

An additional embodiment of the rear axle mounting system is contemplated to include a second rear wheel disposed on the rear axle, the second rear wheel defining a second rear contact region when in contact with the ground, a second rear axle bracket, spaced apart from the first rear axle bracket, and connected to the rear axle, a second upper rear bushing connected to the second rear axle bracket, and a second lower rear bushing connected to the second rear axle bracket. The second upper rear bushing and the second lower rear bushing are adapted to connect the second rear axle bracket to the chassis. The second upper rear bushing is disposed apart from the second lower rear bushing, thereby also forming the rear line that intersects the ground at or behind a second forward edge of the second front contact region.

The present invention also provides for an axle mounting system that includes a first front axle bracket, a front axle connected to the first front axle bracket, a first front wheel disposed on the front axle, the first front wheel defining a first front contact region when in contact with a ground, a first upper front bushing connected to the first front axle bracket, a first lower front bushing connected to the first front axle bracket, a first rear axle bracket, a rear axle connected to the first rear axle bracket, a first rear wheel disposed on the rear axle, the first rear wheel defining a first rear contact region when in contact with the ground, a first upper rear bushing connected to the first rear axle bracket, and a first lower rear bushing connected to the first rear axle bracket. The first upper front bushing and the first lower front bushing are adapted to connect the first front axle bracket to a chassis of a vehicle disposed on the ground. The first upper rear bushing and the first lower rear bushing are adapted to connect the first rear axle bracket to a chassis of the vehicle disposed on the ground. The first upper front bushing is disposed apart from the first lower front bushing, thereby forming a front line that intersects the ground at or ahead of a first forward edge of the first front contact region. The first upper rear bushing is disposed apart from the first lower rear bushing, thereby forming a rear line that intersects the ground at or behind a first rearward edge of the first rear contact region. The front line establishes a front angle with the ground. In addition, the rear line establishes a rear angle with the ground.

With respect to the embodiment of the axle system, it is contemplated that the axle mounting system also may include a second lower front bushing connected between the front axle and the chassis, and a second lower rear bushing connected between the rear axle and the chassis.

Another embodiment of the axle system of the present invention is contemplated to include a second front wheel disposed on the front axle, the second front wheel defining a second front contact region when in contact with the ground, a second front axle bracket, spaced apart from the first front axle bracket, and connected to the front axle, a second upper front bushing connected to the second front axle bracket, a second lower front bushing connected to the second front axle bracket, a second rear wheel disposed on the rear axle, the second rear wheel defining a second rear contact region when in contact with the ground, a second rear axle bracket, spaced apart from the first rear axle bracket, and connected to the rear axle, a second upper rear bushing connected to the second rear axle bracket, and a second lower rear bushing connected to the second rear axle bracket. The second upper front bushing and the second lower front bushing are adapted to connect the second front axle bracket to the chassis. The second upper front bushing is disposed apart from the second lower front bushing, thereby also forming the front line that intersects the ground at or ahead of a second forward edge of the second front contact region. The second upper rear bushing and the second lower rear bushing are adapted to connect the second rear axle bracket to the chassis. In addition, the second upper rear bushing is disposed apart from the second lower rear bushing, thereby also forming the rear line that intersects the ground at or behind a second forward edge of the second front contact region.

In the axle mounting system of the present invention, the front angle and the rear angle contribute to understeer of the vehicle.

It is contemplated that the front angle and the rear angle may be equal to one another.

Alternatively, it is contemplated that the front angle and the rear angle are less than or equal to 90°.

In another embodiment, the front angle may be between about 77°±10° and the rear angle may be between about 68°±10°.

Still further, the front angle may be between about 77°±5° and the rear angle may be between about 68°±5°.

It is also contemplated that the front angle may be between about 77°±2° and the rear angle may be between about 68°±2°.

In another contemplated embodiment, the front angle may be about 77° and the rear angle may be about 68°.

A further embodiment of the axle mounting system of the present invention contemplates the inclusion of a first front suspension assembly connecting the first front wheel to the front axle. The first front suspension assembly may be disposed at least partially within the first front wheel. In addition, the axle mounting system may include a first rear suspension assembly connecting the first rear wheel to the rear axle. The first rear suspension assembly may be disposed at least partially within the first rear wheel.

It is contemplated that the first front wheel and the first rear wheel may be pneumatic tires.

Another contemplated embodiment of the axle mounting system of the present invention may include a first front suspension assembly connecting the first front wheel to the front axle. The first front suspension assembly may be disposed at least partially within the first front wheel. In addition, the axle mounting system may include a first rear suspension assembly connecting the first rear wheel to the rear axle. The first rear suspension assembly may be disposed at least partially within the first rear wheel. In addition, the axle mounting system may have a second front suspension assembly connecting the second front wheel to the front axle. The second front suspension assembly may be disposed at least partially within the second front wheel. The axle mounting system also may include a second rear suspension assembly connecting the second rear wheel to the rear axle. If so, the second rear suspension assembly may be disposed at least partially within the second rear wheel.

It is also contemplated that the first front wheel, the first rear wheel, the second front wheel, and the second rear wheel include pneumatic tires.

In a further contemplated embodiment, a front subframe may be disposed between the first front axle bracket and the front axle, where the front subframe includes a front suspension assembly.

Similarly, a rear subframe may be disposed between the first rear axle bracket and the rear axle, where the rear subframe includes a rear suspension assembly.

In addition, it is contemplated that the first front axle bracket may be a front axle mount integrally formed with the front axle.

Similarly, the first rear axle bracket may be a rear axle mount integrally formed with the rear axle.

The present invention also provides a vehicle that includes a chassis disposable on a ground, a front axle connected to the chassis, a first front wheel disposed on the front axle, the first front wheel defining a first front contact region when in contact with the ground, a first upper front bushing connected to the chassis, and a first lower front bushing connected to the chassis. The first upper front bushing is disposed apart from the first lower front bushing, thereby forming a front line that intersects the ground at or ahead of a first forward edge of the first front contact region. The front line establishes a front angle with the ground.

In an alternative embodiment, the present invention provides a vehicle that includes a chassis disposable on a ground, a rear axle connected to the chassis, a first rear wheel disposed on the rear axle, the first rear wheel defining a first rear contact region when in contact with the ground, a first upper rear bushing connected to the chassis, and a first lower rear bushing connected to the chassis. The first upper rear bushing is disposed apart from the first lower rear bushing, thereby forming a rear line that intersects the ground at or behind a first rearward edge of the first rear contact region. The rear line establishes a rear angle with the ground.

In still another contemplated embodiment, the present invention provides a vehicle that includes a chassis disposable on the ground, a front axle connected to a front end of the chassis, a first front wheel disposed on the front axle, the first front wheel defining a first front contact region when in contact with the ground, a first upper front bushing connected to the chassis, a first lower front bushing connected to the chassis, a rear axle connected to the rear end of the chassis, a first rear wheel disposed on the rear axle, the first rear wheel defining a first rear contact region when in contact with the ground, a first upper rear bushing connected to the chassis, and a first lower rear bushing connected to the chassis. The first upper front bushing is disposed apart from the first lower front bushing, thereby forming a front line that intersects the ground at or ahead of a first forward edge of the first front contact region. The first upper rear bushing is disposed apart from the first lower rear bushing, thereby forming a rear line that intersects the ground at or behind a first rearward edge of the first rear contact region. The front line establishes a front angle with the ground, and the rear line establishes a rear angle with the ground.

Other aspects of the present invention will be made apparent from the discussion that follows.

### BRIEF DESCRIPTION OF THE DRAWINGS

The present invention will now be described in connection with the drawings, in which:

FIG. 1 side view of a portion of a vehicle chassis incorporating the axle mounting system of the present invention;

FIG. 2 is a side view of a portion of the vehicle chassis illustrated in FIG. 1, showing contemplated positions for the bushings disposed between the vehicle axles and the chassis that are part of the axle mounting system of the present invention;

FIG. 3 is a perspective view of a front end of the vehicle chassis illustrated in FIG. 1, illustrating the position of the front axle with respect to the vehicle chassis;

FIG. 4 is a perspective, rear view of the axle mounting system of the present invention that is contemplated for placement at the rear of the chassis;

FIG. 5 is a perspective, front view of one embodiment of the axle mounting system of the present invention that is contemplated for placement at the front of the vehicle chassis;

FIG. 6 is a perspective, rear view of the embodiment of the axle mounting system shown in FIG. 5;

FIG. 7 is a perspective, front view of the axle mounting system shown in FIG. 5, showing selected axle and wheel suspension components; and

FIG. 8 is a perspective, rear view of the components of the axle mounting system of the present invention that are illustrated in FIG. 7.

### DETAILED DESCRIPTION OF EMBODIMENT(S) OF THE INVENTION

The present invention will now be described in connection with one or more contemplated embodiments. The discussion of any one particular embodiment is not intended to be limiting of the present invention. To the contrary, variations and equivalents of the described embodiment(s) will become apparent to those skilled in the art. Those variations and equivalents are intended to be encompassed by the scope of the present invention.

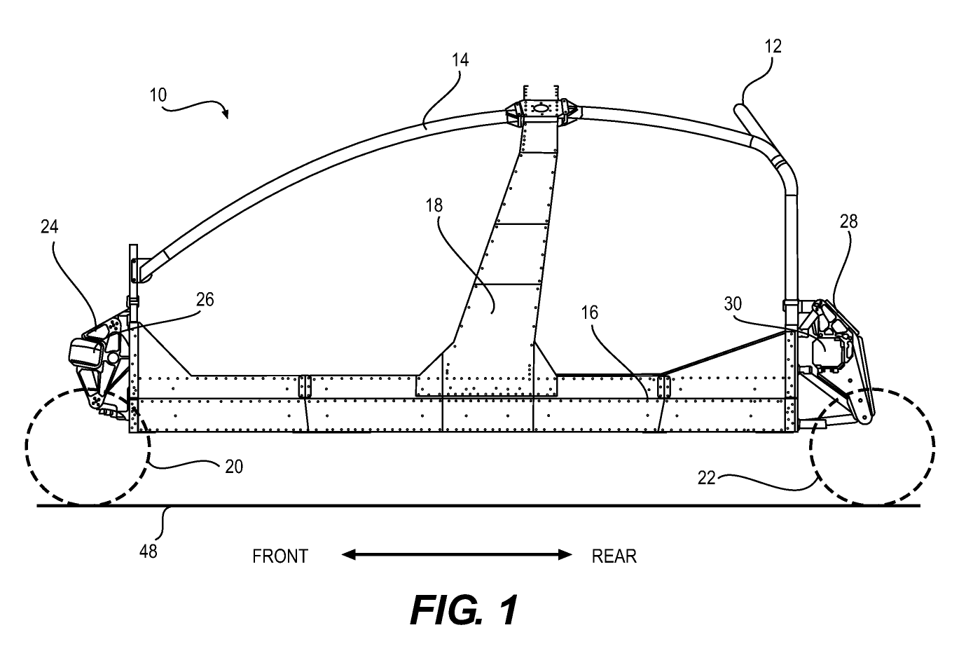

FIG. 1 is a side view of the axle mounting system 10 of the present invention. The axle mounting system 10 is contemplated to cooperate with a suspension system as described in U.S. Pat. No. 8,152,184, the entire contents of which are incorporated herein by reference. As should be apparent from the discussion that follows, however, the present invention may be applicable to conventional suspensions. Accordingly, the present invention is not intended to be limited to applications involving suspensions such as those described in U.S. Pat. No. 8,152,184.

The axle mounting system 10 of the present invention is contemplated to be incorporated into a four-wheeled vehicle, such as an automobile. A chassis 12 for one contemplated embodiment of a light-weight automobile is illustrated in FIG. 1. The chassis 12 includes a top frame element 14, a bottom frame element 16, and an intermediate frame element 18. In the illustrated embodiment, the intermediate frame element 18 connects between the top frame element 14 and the bottom frame element 16. The frame elements 14, 16, 18 are merely illustrative of one contemplated construction for the chassis 12. The chassis 12 may include any number of frame elements 14, 16, 18 without departing from the scope of the present invention.

For reference, the front and rear of the chassis 12 are designated. Front and rear wheels 20, 22 also are shown to provide a context for the axle mounting system 10 of the present invention.

The axle mounting system 10 of the present invention includes a front mounting arrangement 24 that connects to a front axle 26. The axle mounting system 10 of the present invention also includes a rear mounting arrangement 28 that connects to a rear axle 30. The axle mounting system 10 also is contemplated to encompass only one of the front mounting arrangement 24 or the rear mounting arrangement 28. In other words, the present invention is contemplated to encompass a vehicle that includes only the front mounting arrangement 24, the rear mounting arrangement 28, or both the front mounting arrangement 24 and the rear mounting arrangement 28.

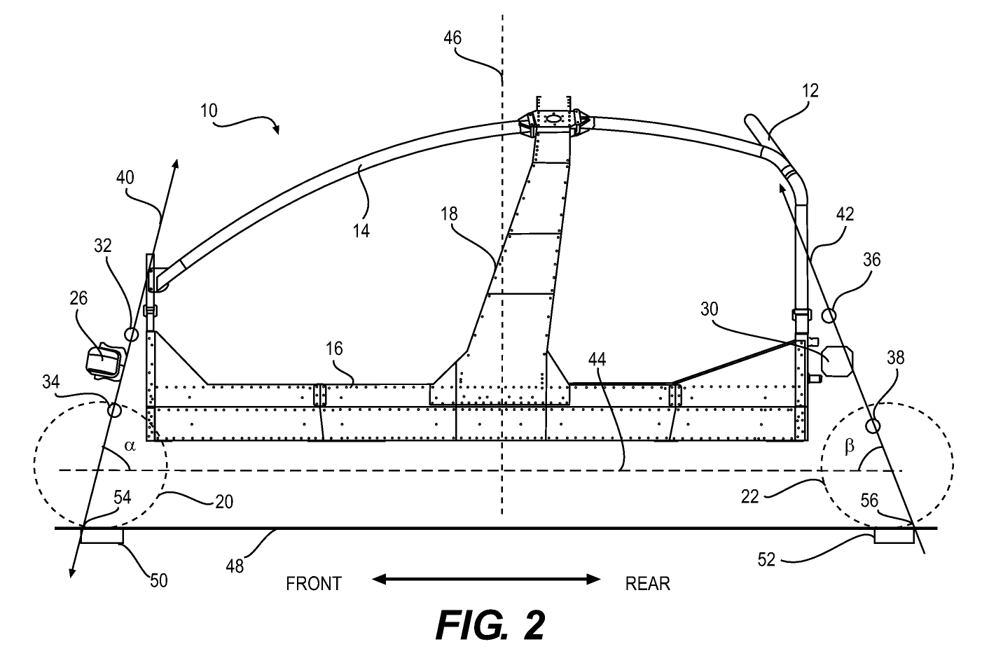

FIG. 2 illustrates the chassis 12 that is shown in FIG. 1. For simplicity, selected details of the front mounting arrangement 24 and the rear mounting arrangement 28 have been removed.

In FIG. 2, the approximate locations for upper front bushings 32 and lower front bushings 34 are shown. At the rear of the chassis 12, the approximate locations for upper rear bushings 36 and lower rear bushings 38 are illustrated. The bushings 32, 34, 36, 38 may be made from any suitable material including, but not limited to, rubber and equivalent, flexible and/or compressible materials. As discussed in greater detail below, the bushings 32, 34, 36, 38 provide a flexible connection between the front axle 26, the rear axle 30, and the chassis 12.

The upper front bushings 32 form a front line 40 with the lower front bushings 34. Similarly, the upper rear bushings 36 form a rear line 42 with the lower rear bushings 38. The front line 40 forms an angle α with respect to a horizontal line 44 consistent with a plane supporting the chassis 12. Similarly, the rear line 42 forms an angle β with respect to the horizontal reference line 44. In the illustrated embodiment, the lines 40, 42 converge toward a central line 46 that is also shown in FIG. 2. The horizontal line 44 that is consistent with the plane supporting the chassis 12 is contemplated to be parallel to the ground 48, as illustrated.

As made apparent from the foregoing, the bushings 32, 34 and 36, 38 have a vertical orientation. What is meant by this is that the upper bushings 32, 36 are positioned above the lower bushings 34, 38. In other words, the bushings 32, 34 and 36, 38 define vertical planes with respect to the horizontal line 44. The bushings 32, 34 and 36, 38 also define the lines 40, 42, which are vertically oriented. It is noted that this nomenclature is not intended to refer to the orientations of individual ones of the bushings 32, 34, 36, 38. As illustrated in the drawings, the axes of the bushings (i.e., the bolts or fasteners passing through the bushings) are oriented horizontally, because they connect the chassis brackets 58, 60 and the axle brackets 62, 64 to one another for the front mounting arrangement 24, as discussed in greater detail below. The same orientation exists for the axle brackets 66, 68, 70 associated with the rear mounting arrangement 26.

With respect to the embodiment(s) discussed in connection with the axle mounting system 10 of the present invention, the wheels 20, 22 are contemplated to be provided with pneumatic tires. As such, while not intended to be limiting of the present invention, the terms “wheels” and “pneumatic tires” are used interchangeably herein. It is noted, however, that the term “wheel” is intended to encompass a broader scope than the term “pneumatic tire.” For example, a solid rubber wheel is contemplated to be encompassed by the term “wheel,” but a solid rubber wheel would not be understood to by a pneumatic tire.

When installed on a vehicle, pneumatic tires 20, 22 tend to flatten at the points where the pneumatic tires 20, 22 contact the ground 48. These flattened areas define the front and rear contact regions 50, 52 illustrated in FIG. 2. The contact regions 50, 52 have lengths consistent with the degree of flattening of the pneumatic tires 20, 22. While not illustrated in FIG. 2, the contact regions 50, 52 also have widths consistent with the widths of the pneumatic tires 20, 22 and the degree of flattening of those pneumatic tires 20, 22.

The behavior of pneumatic tires 20, 22 on a vehicle may be described in association with a property of the pneumatic tires 20, 22 known as the “pneumatic trail.” A “pneumatic trail” or “trail” of a tire 20, 22 is a trail-like effect generated by compliant tires rolling on a hard surface and subject to side loads (i.e., lateral forces), as in a turn. More technically, the “pneumatic trail” is the distance that the resultant force of side-slip occurs behind the geometric center of the contact patch 50, 52 between the wheel 20, 22 and the ground 48. As should be apparent to those skilled in the art, the pneumatic trail may migrate from the contact region 50, 52 associated with a wheel 20, 22 depending upon the lateral forces applied to the wheel 20, 22.

It is noted that, in cases where the wheel 20, 22 does not incorporate a pneumatic tire, the “trail” may be coextensive with the contact patch 50, 52. In other words, for some wheels 20, 22, the trail may not depart from the contact patch 50, 52 under applied dynamic conditions.

Without limiting the definition of this property of a pneumatic tire 20, 22, pneumatic trails are defined, in part, by the mechanical and chemical properties of the pneumatic tires 20, 22. These properties include, for example, the hardness of the rubber, the tackiness of the rubber, the chemical composition of the rubber, the amount of inflation of the pneumatic tire 20, 22, etc.

As should be apparent from the foregoing, the pneumatic trail associated with an individual pneumatic tire 20, 22 is largely consistent with the contact region 50, 52 between that pneumatic tire 20, 22 and the ground 48. As a result, the present invention treats the contact regions 50, 52 and the locations of the pneumatic trails for the pneumatic tires 20, 22 as being substantially consistent with one another. Therefore, while aspects of the present invention are discussed in connection with identified contact regions 50, 52, the invention is contemplated to encompass the pneumatic trails for the pneumatic tires 20, 22 and not solely the contact regions 50, 52 illustrated.

Returning to FIG. 2, the front line 40 is contemplated to extend to a front point 54 on the ground 48 in front of the front contact region 50. The rear line 42 is contemplated to extend to a rear point 56 on the ground 48 behind the rear contact region 52. In particular, the present invention contemplates that the front line 40 intersects with the ground 48 at a location (i.e., at the front point 54) that is at the leading edge or ahead of the leading edge of the front contact region 50. Similarly, the present invention contemplates that the rear line 42 intersects with the ground 48 at a location (i.e., at the rear point 56) that is at the trailing edge or behind of the trailing edge of the rear contact region 52.

When the lines 40, 42 intersect with the ground 48 ahead of and behind the contact regions 50, 52, and the lines 40, 42 tilt toward the center of the vehicle chassis 12, the compliance of the vehicle tends toward understeer when the vehicle is in roll when turning, as well as other load situations. As should be appreciated by those skilled in the art, understeer provides specific handling characteristics for a vehicle that may be desirable. Since the concept of understeer and oversteer should be familiar to those skilled in the art, further discussion of these automotive principles are not provided herein.

With respect to the embodiment of the axle mounting system illustrated in FIG. 2, for example, the angles α, β are contemplated to be less than 90°, respectively. Since the front point 54 is ahead of the front contact region 50 and the rear point 56 is behind the rear contact region 52, the lines 40, 42 are contemplated to be angled toward the vertical reference line 44.

In the embodiment illustrated in FIG. 2, the angle α is contemplated to be about 77°±10°. The angle β is contemplated to be about 68°±10°. In a further contemplated embodiment, the angle α may be about 77°±5° and the angle β may be about 68°±5°. In another contemplated embodiment, the angle α may be about 77°±2° and the angle β may be about 68°±2°. In a specific embodiment, it is contemplated that the angle α is about 77° and the angle β is about 68°. As should be apparent, however, the angles α, β may be less than 90°, equal to 90°, or greater than 90° without departing from the scope of the invention. Still further the angles α, β may differ from one another, as illustrated in FIG. 2. Alternatively, the angles α, β may be the same as one another.

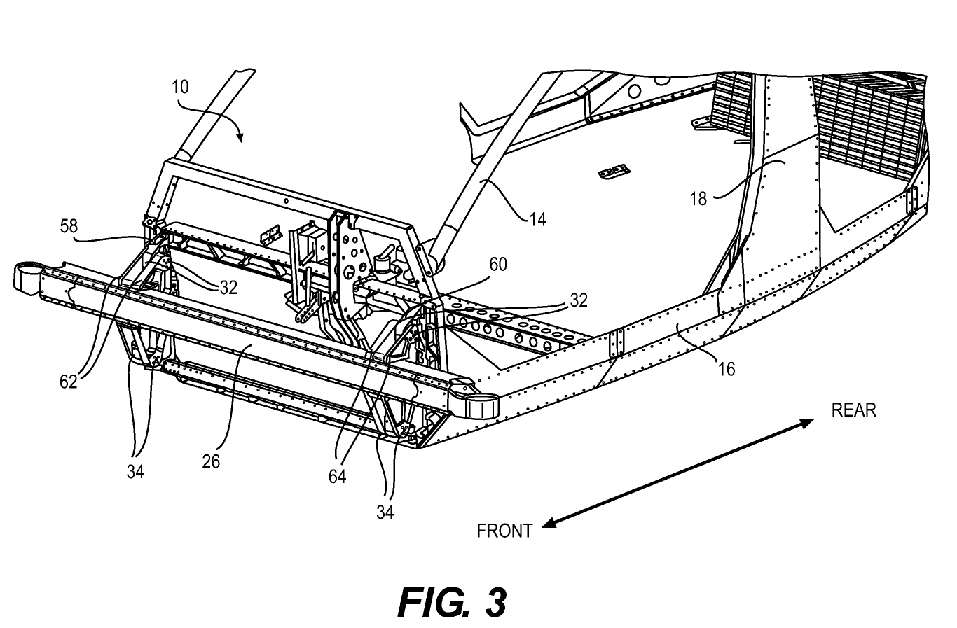

FIG. 3 illustrates the front mounting arrangement 24 in greater detail. The front mounting arrangement 24 includes two chassis brackets 58, 60. Alternatively, the chassis brackets 58, 60 may be incorporated into (or attached to) a bulkhead, substructure, or other portion of the chassis 12 without departing from the scope of the present invention. The chassis brackets 58, 60 are connected to two pairs of axle brackets 62, 64 via the bushings 32, 34. As should be apparent from FIG. 3, there are four bushings 32, 34 in total in the illustrated embodiment.

It is noted that the front axle brackets 62, 64 may be components separate from the front axle 26. In another contemplated embodiment, the front axle brackets 62, 64 may be integrally formed with the front axle 26. In this variant, the integrally formed axle brackets may be referred to as “axle mounts” by those skilled in the art. The present invention is contemplated to encompass both variants, among others, for the axle brackets 62, 64 regardless of the nomenclature employed.

As also should be apparent from FIG. 3, the axle brackets 62, 64 are connected to the front axle 26. The chassis brackets 58, 60 are connected to the chassis 12. The bushings 32, 34 provide a flexible connection between the axle brackets 62, 64 and the chassis brackets 58, 60. As a result, the bushings 32, 34 provide dampened motion between the axle 26 and the chassis 12. In particular, the bushings 32, 34 assist with damping of vibrational motion, among other types of motion.

With respect to the front mounting arrangement 24, it is noted that the bushings 32, 34 also are vertically aligned with one another in the illustrated embodiment, when viewed from the front of the chassis 12. While this arrangement is provided for the illustrated embodiment, the bushings 32, 34 may be offset from one another without departing from the scope of the present invention. In other words, when viewing the chassis 12 from the front, the upper front bushing 32 is above the lower front bushing 34 and the front bushings 32, 34 define a vertical line 40 perpendicular to the horizontal line 44. While this orientation is contemplated for the present invention, the front bushings 32, 34, when viewed from the front of the chassis 12 may define a vertical line 40 that is disposed at an angle to the horizontal line 44. Either orientation is contemplated to fall within the scope of the present invention.

It is noted that, in one contemplated embodiment, the front mounting arrangement 24 may be provided with one upper front bushing 32 and two lower front bushings 34. In this arrangement, the upper front bushing 32 may be centrally located at or near to a center point of the front axle 26. With respect to this embodiment, it is contemplated that the front mounting arrangement 24 may have a minimum of three bushings 32, 34 associated therewith. In addition, it is possible that the front mounting arrangement 24 may have only one upper front bushing 32 and one lower front bushing 34. However, an arrangement with one upper front bushing 32 and two lower front bushing 34 is contemplated to be a more functional example of the front mounting arrangement 24. As should be apparent, however, the front mounting arrangement 24 may include any number of upper front bushings 32 and lower front bushings 34 without departing from the scope of the present invention.

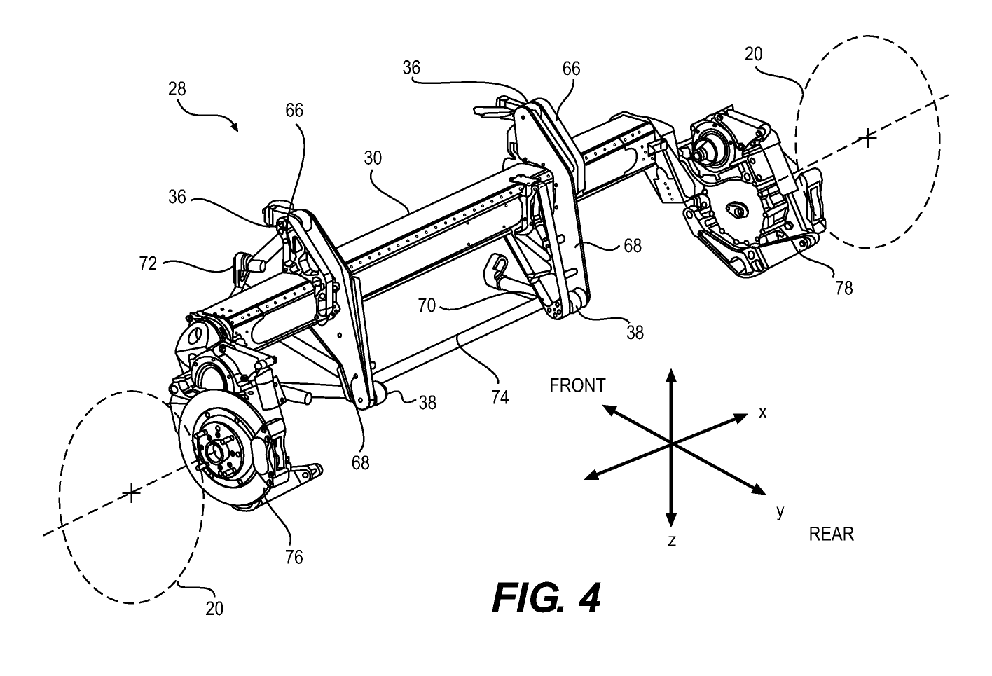

FIG. 4 illustrates the rear mounting arrangement 28. In this arrangement, three axle brackets 66, 68, 70 are attached to the rear axle 30. The bushings 36, 38 connect the axle brackets 66, 68, 70 to connecting frame elements 72, 74, which are attached to the chassis 12. Frame elements 72, 74 also may be incorporated into the chassis 12 or replaced by another rigid structure that holds the bushings 36, 38 in the proper location. The bushings 36, 38 provide damping, as discussed above. It is noted that the bushings 36, 38 for the rear mounting arrangement 28 are not vertically aligned when viewed from the front (or rear) of the chassis 12. Instead, they are offset from one another in the illustrated embodiment.

It is noted that the front rear brackets 66, 68, 70 may be components separate from the rear axle 30. In another contemplated embodiment, the rear axle brackets 66, 68, 70 may be integrally formed with the rear axle 30. In this variant, the integrally formed axle brackets may be referred to as “axle mounts” by those skilled in the art. The present invention is contemplated to encompass both variants, among others, for the rear axle brackets 66, 68, 70 regardless of the nomenclature employed.

It is noted that, in one contemplated embodiment, the rear mounting arrangement 28 may be provided with one upper rear bushing 36 and two lower rear bushings 38. In this arrangement, the upper rear bushing 34 may be centrally located at or near to a center point of the rear axle 30. With respect to this embodiment, it is contemplated that the rear mounting arrangement 28 may have a minimum of three bushings 36, 38 associated therewith. In addition, it is possible that the rear mounting arrangement 28 may have only one upper rear bushing 36 and one lower rear bushing 38. However, an arrangement with one upper rear bushing 36 and two lower rear bushings 38 is contemplated to be a more functional example of the rear mounting arrangement 28. As should be apparent, however, the rear mounting arrangement 28 may include any number of upper rear bushings 36 and lower rear bushings 38 without departing from the scope of the present invention.

In addition, with respect to the rear mounting arrangement 28, it is noted that the bushings 36, 38 also are vertically aligned with one another in the illustrated embodiment, when viewed from the front of the chassis 12. While this arrangement is provided for the illustrated embodiment, the bushings 36, 38 may be offset from one another without departing from the scope of the present invention. In other words, when viewing the chassis 12 from the front, the upper rear bushing 36 is above the lower rear bushing 38 and the rear bushings 36, 38 define a vertical line 42 perpendicular to the horizontal line 44. While this orientation is contemplated for the present invention, the rear bushings 36, 38, when viewed from the front of the chassis 12 may define a vertical line 42 that is disposed at an angle to the horizontal line 44. Either orientation is contemplated to fall within the scope of the present invention.

Additionally, as noted above, when viewed from the front of the chassis 12, the front bushings 32, 34 and the rear bushings 36, 38 are contemplated to be oriented vertically, such that they form a line that is perpendicular to a horizontal plane defined by the horizontal line 44 (or the ground 48). In other words, it is contemplated that, when viewed from the front, the bushings 32, 34, and 36, 38 will define vertical lines that are parallel to one another. The present invention, however, also is contemplated to encompass designs where the bushings 32, 34 and 36, 38 define vertical lines that converge toward the centerline of the chassis 12. Still further, the present invention is contemplated to encompass designs where the bushings 32, 34 and 36, 38 define lines that diverge from the centerline of the chassis 12.

In FIG. 4, suspension assemblies 76, 78 for the wheels 20 are illustrated for context. As noted above, the suspension assemblies 76, 78 are contemplated to be mounted within the wheels 20, 22. However, the present invention should not be understood to be limited solely to suspension assemblies 76, 78 that are mounted within the wheels 20, 22.

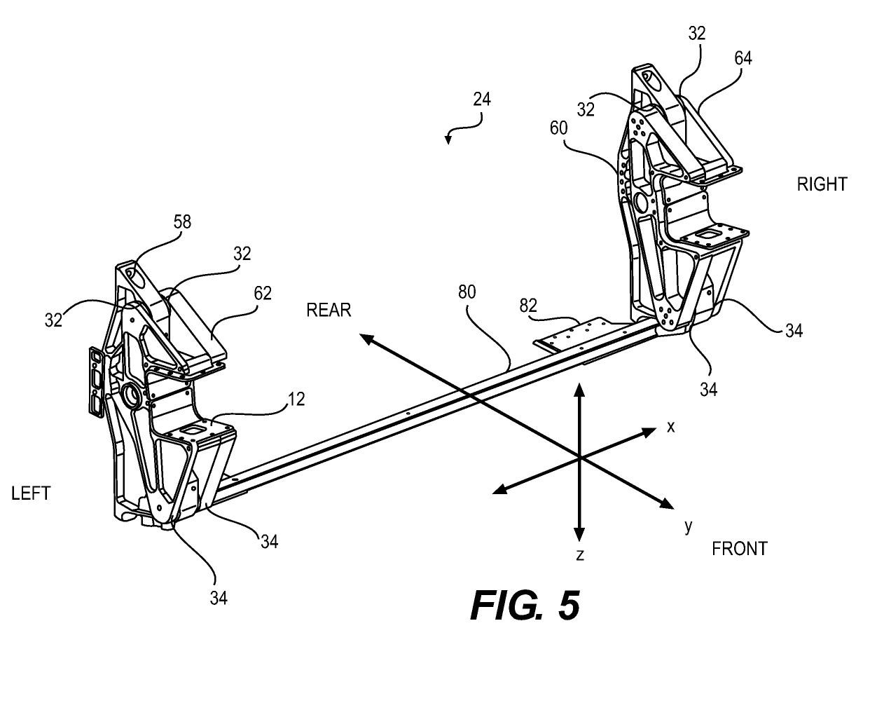

FIG. 5 is an enlarged, perspective detail of a portion of the front mounting assembly 24 of the axle mounting system 10 of the present invention. In this view, the front axle 26 has been removed to assist with an understanding of the invention. Also shown is a connecting frame element 80 and one of two brackets 82 that help to connect the front mounting assembly 24 to the chassis 12.

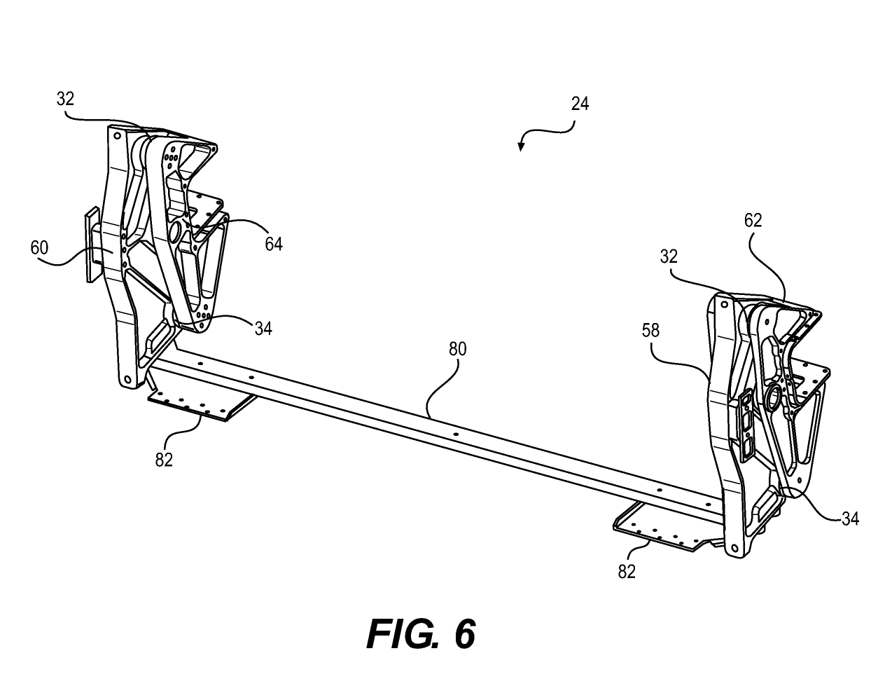

FIG. 6 is a perspective, rear view of the portion of the front mounting assembly 24 that is illustrated in FIG. 5. This view provides additional detail concerning the arrangement of the various components of the front mounting assembly 24.

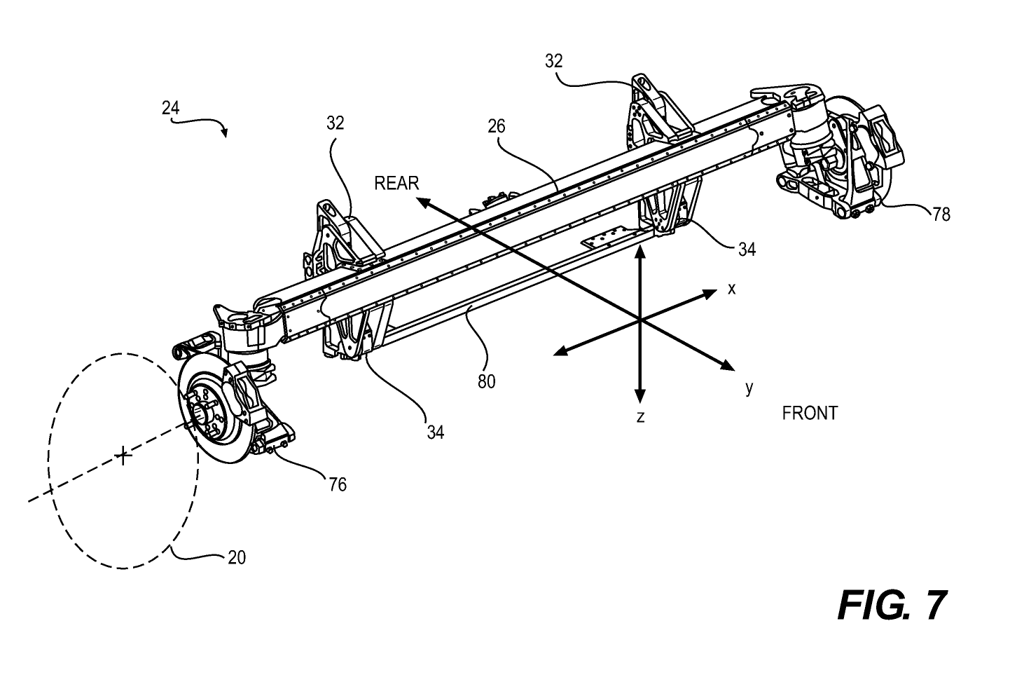

FIG. 7 is a perspective, front view of the front mounting assembly 24 including the axle 26 and the suspension assemblies 76, 78.

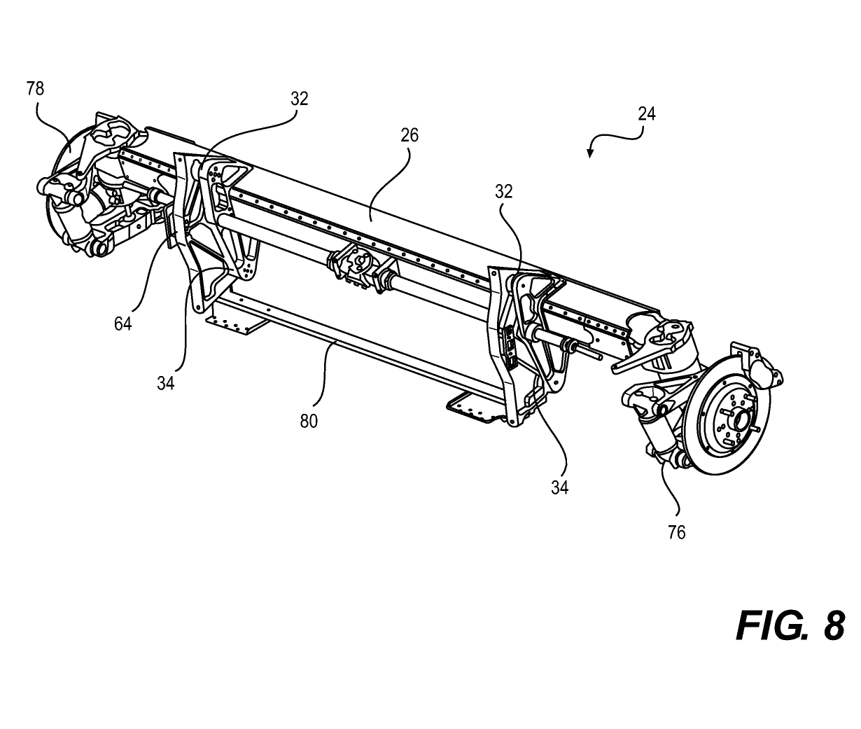

FIG. 8 is a rear view of the front mounting assembly 24 illustrated in FIG. 7.

As should be apparent from the foregoing, the axle mounting system 10 of the present invention is contemplated to provide a suitable and effective mounting arrangement for a compact suspension 76, 78 on a vehicle chassis 12.

The axle mounting system 10 of the present invention provides for a construction whereby the bushings 32, 34, 36, 38 are disposed such that noise and vibration may be isolated from the chassis. In addition, the arrangement of the components in the axle mounting system 10 of the present invention may assist with understeer of the vehicle including the axle mounting system 10.

As should be apparent to those skilled in the art, because the axle mounting assembly 10 includes the bushings 32, 34, 36, 38 (among other features), the present invention may insulate noise and vibration from the chassis 12. Moreover, the bushings 32, 34, 36, 38 provide at least limited elasticity so that forces are not transferred directly to the chassis 12. In addition, the bushings 32, 34, 36, 38 may introduce distortions that are considered advantageous, such as the ability to contribute to understeer, among other advantages.

As should be apparent from the foregoing, while embodiments of the present invention are discussed in relation to the front mounting assembly 24, the same principles, construction, elements, and features are applicable equally to the rear mounting assembly 26.

As also should be apparent from the foregoing, the present invention is contemplated to be directed to a front mounting assembly 24 alone, a rear mounting assembly 26 alone, or the combination of a front mounting assembly 24 and a rear mounting assembly 26. Other combinations, as may be appreciated by those skilled in the art, also are contemplated to fall within the scope of the present invention.

As discussed above, the present invention is contemplated to be employed in designs incorporating suspensions like the ones described in U.S. Pat. No. 8,152,184. The suspensions described in U.S. Pat. No. 8,152,184 cooperate with the suspension assemblies 76, 78 that are disposed at least partially within the wheels 20, 22 of the vehicle. In the alternative, it is contemplated that the present invention may cooperate with a conventional suspension. In such an arrangement, a conventional subframe may be attached to the chassis 12 via the mounting arrangement 10, 24, 28 (or a variation thereof) as described herein. As such, a subframe may be substituted for the axles 26, 30, thereby permitting a traditional suspension to be attached to the chassis 12. In another variant, a subframe may be interposed between the axles 26, 30 and the bushings 32, 34, 36, 38. Still other variants are contemplated to be encompassed by the present invention.

As noted above, the present invention is described in connection with one or more embodiments thereof. The present invention is not intended to be limited thereto. To the contrary, upon reading the foregoing, those skilled in the art will readily appreciate that there are variations and equivalents of the described embodiments that may be employed. Those variations and equivalents are intended to be encompassed by the scope of the present invention.

What is claimed is:

1. A front axle mounting system, comprising:
a first front axle bracket;
a front axle connected to the first front axle bracket;
a first front wheel disposed on the front axle, the first front wheel defining a first front contact region when in contact with a ground;
a first upper front bushing connected to the first front axle bracket; and
a first lower front bushing connected to the first front axle bracket,
wherein the first upper front bushing and the first lower front bushing are adapted to connect the first front axle bracket to a chassis of a vehicle disposed on the ground,
wherein the first upper front bushing is disposed apart from the first lower front bushing, thereby forming a front line that intersects the ground at or ahead of a first forward edge of the first front contact region, and
wherein the front line establishes a front angle with the ground.

2. The front axle mounting system of claim 1, further comprising:
a second lower front bushing connected between the front axle and the chassis.

3. The front axle mounting system of claim 1, further comprising:
a second front wheel disposed on the front axle, the second front wheel defining a second front contact region when in contact with the ground;
a second front axle bracket, spaced apart from the first front axle bracket, and connected to the front axle;
a second upper front bushing connected to the second front axle bracket; and
a second lower front bushing connected to the second front axle bracket,
wherein the second upper front bushing and the second lower front bushing are adapted to connect the second front axle bracket to the chassis, and
wherein the second upper front bushing is disposed apart from the second lower front bushing, thereby also forming the front line that intersects the ground at or ahead of a second forward edge of the second front contact region.

4. A rear axle mounting system, comprising:
a first rear axle bracket;
a rear axle connected to the first rear axle bracket;
a first rear wheel disposed on the rear axle, the first rear wheel defining a first rear contact region when in contact with a ground;
a first upper rear bushing connected to the first rear axle bracket; and
a first lower rear bushing connected to the first rear axle bracket,
wherein the first upper rear bushing and the first lower rear bushing are adapted to connect the first rear axle bracket to a chassis of a vehicle disposed on the ground,
wherein the first upper rear bushing is disposed apart from the first lower rear bushing, thereby forming a rear line that intersects the ground at or behind a first rearward edge of the first rear contact region, and
wherein the rear line establishes a rear angle with the ground.

5. The rear axle mounting system of claim 4, further comprising:
a second lower rear bushing connected between the rear axle and the chassis.

6. The rear axle mounting system of claim 4, further comprising:
a second rear wheel disposed on the rear axle, the second rear wheel defining a second rear contact region when in contact with the ground;
a second rear axle bracket, spaced apart from the first rear axle bracket, and connected to the rear axle;
a second upper rear bushing connected to the second rear axle bracket; and
a second lower rear bushing connected to the second rear axle bracket,
wherein the second upper rear bushing and the second lower rear bushing are adapted to connect the second rear axle bracket to the chassis, and
wherein the second upper rear bushing is disposed apart from the second lower rear bushing, thereby also forming the rear line that intersects the ground at or behind a second forward edge of the second front contact region.

7. An axle mounting system, comprising:
a first front axle bracket;
a front axle connected to the first front axle bracket;
a first front wheel disposed on the front axle, the first front wheel defining a first front contact region when in contact with a ground;
a first upper front bushing connected to the first front axle bracket;
a first lower front bushing connected to the first front axle bracket;
a first rear axle bracket;
a rear axle connected to the first rear axle bracket;
a first rear wheel disposed on the rear axle, the first rear wheel defining a first rear contact region when in contact with the ground;
a first upper rear bushing connected to the first rear axle bracket; and
a first lower rear bushing connected to the first rear axle bracket,
wherein the first upper front bushing and the first lower front bushing are adapted to connect the first front axle bracket to a chassis of a vehicle disposed on the ground,
wherein the first upper rear bushing and the first lower rear bushing are adapted to connect the first rear axle bracket to a chassis of the vehicle disposed on the ground,
wherein the first upper front bushing is disposed apart from the first lower front bushing, thereby forming a front line that intersects the ground at or ahead of a first forward edge of the first front contact region,
wherein the first upper rear bushing is disposed apart from the first lower rear bushing, thereby forming a rear line that intersects the ground at or behind a first rearward edge of the first rear contact region,
wherein the front line establishes a front angle with the ground, and
wherein the rear line establishes a rear angle with the ground.

8. The axle mounting system of claim 7, further comprising:
a second lower front bushing connected between the front axle and the chassis; and
a second lower rear bushing connected between the rear axle and the chassis.

9. The axle mounting system of claim 7, further comprising:
a second front wheel disposed on the front axle, the second front wheel defining a second front contact region when in contact with the ground;
a second front axle bracket, spaced apart from the first front axle bracket, and connected to the front axle;
a second upper front bushing connected to the second front axle bracket;
a second lower front bushing connected to the second front axle bracket,
a second rear wheel disposed on the rear axle, the second rear wheel defining a second rear contact region when in contact with the ground;
a second rear axle bracket, spaced apart from the first rear axle bracket, and connected to the rear axle;
a second upper rear bushing connected to the second rear axle bracket; and
a second lower rear bushing connected to the second rear axle bracket,
wherein the second upper front bushing and the second lower front bushing are adapted to connect the second front axle bracket to the chassis,
wherein the second upper front bushing is disposed apart from the second lower front bushing, thereby also forming the front line that intersects the ground at or ahead of a second forward edge of the second front contact region,
wherein the second upper rear bushing and the second lower rear bushing are adapted to connect the second rear axle bracket to the chassis, and
wherein the second upper rear bushing is disposed apart from the second lower rear bushing, thereby also forming the rear line that intersects the ground at or behind a second forward edge of the second front contact region.

10. The axle mounting system of claim 7, wherein the front angle and the rear angle contribute to understeer of the vehicle.

11. The axle mounting system of claim 7, wherein the front angle and the rear angle are equal to one another.

12. The axle mounting system of claim 7, wherein the front angle and the rear angle are less than or equal to 90°.

13. The axle mounting system of claim 12, wherein the front angle is between about 77°±10° and the rear angle is between about 68°±10°.

14. The axle mounting system of claim 13, wherein the front angle is between about 77°±5° and the rear angle is between about 68°±5°.

15. The axle mounting system of claim 14, wherein the front angle is between about 77°±2° and the rear angle is between about 68°±2°.

16. The axle mounting system of claim 15, wherein the front angle is about 77° and the rear angle is about 68°.

17. The axle mounting system of claim 7, further comprising:
a first front suspension assembly connecting the first front wheel to the front axle, wherein the first front suspension assembly is disposed at least partially within the first front wheel; and
a first rear suspension assembly connecting the first rear wheel to the rear axle, wherein the first rear suspension assembly is disposed at least partially within the first rear wheel.

18. The axle mounting system of claim 17, wherein the first front wheel and the first rear wheel comprise pneumatic tires.

19. The axle mounting system of claim 9, further comprising:
a first front suspension assembly connecting the first front wheel to the front axle, wherein the first front suspension assembly is disposed at least partially within the first front wheel;
a first rear suspension assembly connecting the first rear wheel to the rear axle, wherein the first rear suspension assembly is disposed at least partially within the first rear wheel;
a second front suspension assembly connecting the second front wheel to the front axle, wherein the second front suspension assembly is disposed at least partially within the second front wheel; and
a second rear suspension assembly connecting the second rear wheel to the rear axle, wherein the second rear suspension assembly is disposed at least partially within the second rear wheel.

20. The axle mounting system of claim 19, wherein the first front wheel, the first rear wheel, the second front wheel, and the second rear wheel comprise pneumatic tires.

21. The front axle mounting system of claim 1, further comprising:
a front subframe disposed between the first front axle bracket and the front axle, wherein the front subframe comprises a front suspension assembly.

22. The rear axle mounting system of claim 4, further comprising:
a rear subframe disposed between the first rear axle bracket and the rear axle, wherein the rear subframe comprises a rear suspension assembly.

23. The axle mounting system of claim 7, further comprising:
a front subframe disposed between the first front axle bracket and the front axle, wherein the front subframe comprises a front suspension assembly, and
a rear subframe disposed between the first rear axle bracket and the rear axle, wherein the rear subframe comprises a rear suspension assembly.

24. The front axle mounting system of claim 1, wherein the first front axle bracket is a front axle mount integrally formed with the front axle.

25. The rear axle mounting system of claim 4, wherein the first rear axle bracket is a rear axle mount integrally formed with the rear axle.

26. The axle mounting system of claim 7, wherein the first front axle bracket is a front axle mount integrally formed with the front axle, and the first rear axle bracket is a rear axle mount integrally formed with the rear axle.

27. A vehicle, comprising:
a chassis disposable on a ground;
a front axle connected to the chassis;
a first front wheel disposed on the front axle, the first front wheel defining a first front contact region when in contact with the ground;
a first upper front bushing connected to the chassis; and
a first lower front bushing connected to the chassis,
wherein the first upper front bushing is disposed apart from the first lower front bushing, thereby forming a front line that intersects the ground at or ahead of a first forward edge of the first front contact region, and
wherein the front line establishes a front angle with the ground.

28. A vehicle, comprising:
a chassis disposable on a ground;
a rear axle connected to the chassis;
a first rear wheel disposed on the rear axle, the first rear wheel defining a first rear contact region when in contact with the ground;
a first upper rear bushing connected to the chassis; and
a first lower rear bushing connected to the chassis,
wherein the first upper rear bushing is disposed apart from the first lower rear bushing, thereby forming a rear line that intersects the ground at or behind a first rearward edge of the first rear contact region, and
wherein the rear line establishes a rear angle with the ground.

29. A vehicle, comprising:
a chassis disposable on the ground;
a front axle connected to a front end of the chassis;
a first front wheel disposed on the front axle, the first front wheel defining a first front contact region when in contact with the ground;
a first upper front bushing connected to the chassis;
a first lower front bushing connected to the chassis;
a rear axle connected to the rear end of the chassis;
a first rear wheel disposed on the rear axle, the first rear wheel defining a first rear contact region when in contact with the ground;
a first upper rear bushing connected to the chassis; and
a first lower rear bushing connected to the chassis,
wherein the first upper front bushing is disposed apart from the first lower front bushing, thereby forming a front line that intersects the ground at or ahead of a first forward edge of the first front contact region,
wherein the first upper rear bushing is disposed apart from the first lower rear bushing, thereby forming a rear line that intersects the ground at or behind a first rearward edge of the first rear contact region,
wherein the front line establishes a front angle with the ground, and
wherein the rear line establishes a rear angle with the ground.
